(19) United States
(12) Patent Application Publication
(10) Pub. No.: US 2026/0170986 A1
(43) Pub. Date: Jun. 18, 2026

(54) ELECTRONIC DEVICE, METHOD, AND NON-TRANSITORY COMPUTER-READABLE STORAGE MEDIUM FOR ADJUSTING COLOR TEMPERATURE OF SCREEN

(71) Applicant: Samsung Electronics Co., Ltd., Suwon-si (KR)

(72) Inventors: Eunjin LEE, Suwon-si (KR); Seungryeol KIM, Suwon-si (KR); Kyoungmin PARK, Suwon-si (KR); Minwoo LEE, Suwon-si (KR); Kwangtai KIM, Suwon-si (KR); Donghwy KIM, Suwon-si (KR); Dongheon SHIN, Suwon-si (KR); Donghyun YEOM, Suwon-si (KR)

(21) Appl. No.: 19/532,364

(22) Filed: Feb. 6, 2026

Related U.S. Application Data
(63) Continuation of application No. PCT/KR2024/008796, filed on Jun. 25, 2024.

(30) Foreign Application Priority Data
Aug. 31, 2023 (KR) 10-2023-0115881
Oct. 10, 2023 (KR) 10-2023-0134696

(51) Int. Cl. G09G 3/20

(52) U.S. Cl. CPC G09G 3/2003; G09G 2310/08; G09G 2320/0666; G09G 2360/144

(57) ABSTRACT

An electronic device is provided. The electronic device includes memory including one or more storage media storing, at least one camera, an ambient light sensor, a display, and at least one processor including processing circuitry communicatively coupled to the at least one camera, the illuminance sensor, the display and the memory, wherein the instructions, when executed by the at least one processor individually or collectively, cause the electronic device to check a level of change of brightness of environment around the electronic device based on sensing data obtained by using the illuminance sensor, while a screen is displayed on the display and the at least one camera is disabled, based on the level lower than a reference level, maintain to disable the at least one camera, and based on the level higher than or equal to the reference level enable the at least one camera, and adjust a color temperature of the screen displayed on the display, according to color temperature of the environment recognized by using the enabled at least one camera.

### CROSS-REFERENCE TO RELATED APPLICATION(S)

This application is a continuation application, claiming priority under 35 U.S.C. § 365(c), of an International application No. PCT/KR2024/008796, filed on Jun. 25, 2024, which is based on and claims the benefit of a Korean patent application number 10-2023-0115881, filed on Aug. 31, 2023, in the Ministry of Intellectual Property, and of a Korean patent application number 10-2023-0134696, filed on Oct. 10, 2023, in the Ministry of Intellectual Property, the disclosure of each of which is incorporated by reference herein in its entirety.

### BACKGROUND

### 1. Field

The disclosure relates to an electronic device, a method, and a non-transitory computer-readable storage medium for adjusting a color temperature of a screen.

### 2. Description of Related Art

An electronic device may include a display. The display may be used for displaying an image. The display may include a display panel and display driver circuitry. The display driver circuitry may be operably (or operatively) coupled with the display panel. The display driver circuitry may be configured to display, on the display panel, the image obtained from a processor of the electronic device.

The above information is presented as background information only to assist with an understand the disclosure. No determination has been made, and no assertion is made, as to whether any of the above-might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, a method, and a non-transitory computer-readable storage medium for adjusting a color temperature of a screen.

Additional aspects will be set forth in part in the description which follows and, in part, will be apparent from the description, or may be learned by practice of the presented embodiments.

In accordance with an aspect of the disclosure, an electronic device is provided. The electronic device includes memory including one or more storage media storing instructions, at least one camera, an illuminance sensor, a display, and at least one processor including processing circuitry communicatively coupled to the at least one camera, the illuminance sensor, the display and the memory, wherein the instructions, when executed by the at least one processor individually or collectively, cause the electronic device to check a level of change of brightness of environment around the electronic device based on sensing data obtained by using the illuminance sensor, while a screen is displayed on the display and the at least one camera is disabled, based on the level lower than a reference level, maintain to disable the at least one camera, and based on the level higher than or equal to the reference level, enable the at least one camera, and adjust a color temperature of the screen displayed on the display, according to color temperature of the environment recognized by using the enabled at least one camera.

In accordance with another aspect of the disclosure, a method performed by an electronic device with at least one camera, an illuminance sensor, and a display is provided. The method includes checking, by the electronic device, a level of change of brightness of environment around the electronic device based on sensing data obtained by using the illuminance sensor, while a screen is displayed on the display and the at least one camera is disabled, based on the level lower than a reference level, maintaining, by the electronic device, to disable the at least one camera,, and based on the level higher than or equal to the reference level, enabling, by the electronic device, the at least one camera, and adjusting, by the electronic device, a color temperature of the screen displayed on the display, according to color temperature of the environment recognized by using the enabled at least one camera.

In accordance with another aspect of the disclosure, one or more non-transitory computer readable storage media storing one or more computer programs, including computer-executable instructions that, when executed by an electronic device individually or collectively with at least one camera, an illuminance sensor, and a display, cause the electronic device to perform operations are provided. The operations include checking, by the electronic device, a level of change of brightness of environment around the electronic device based on sensing data obtained by using the illuminance sensor, while a screen is displayed on the display and the at least one camera is disabled, based on the level lower than a reference level, maintaining, by the electronic device, to disable the at least one camera, and based on the level higher than or equal to the reference level, enabling, by the electronic device, the at least one camera, and adjusting, by the electronic device, a color temperature of the screen displayed on the display, according to color temperature of the environment recognized by using the enabled at least one camera.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of changing a color temperature of a screen displayed on a display of an electronic device based on a color temperature of an environment around the electronic device according to an embodiment of the disclosure;

FIG. 2 is a simplified block diagram of an electronic device according to an embodiment of the disclosure;

FIG. 3 illustrates an example of at least one camera, an illuminance sensor, and a display according to an embodiment of the disclosure;

FIG. 4 is a flowchart illustrating a method of enabling at least one camera to adjust a color temperature of a screen according to a color temperature of an environment according to an embodiment of the disclosure;

FIG. 5 is a flowchart illustrating a method of setting a time enabling at least one camera according to brightness of an environment according to an embodiment of the disclosure;

FIG. 6 is a chart illustrating a change in a color temperature measured by using at least one camera according to an embodiment of the disclosure;

FIG. 7 is a flowchart illustrating a method of setting a time enabling at least one camera according to another color temperature according to an embodiment of the disclosure;

FIG. 8 is a chart illustrating a distribution of colors according to color temperature according to an embodiment of the disclosure;

FIG. 9 is a flowchart illustrating a method of selecting a camera used for adjusting a color temperature of a screen according to brightness of an environment according to an embodiment of the disclosure;

FIG. 10 is a flowchart illustrating a method of enabling at least one camera to adjust a color temperature of a screen according to a color temperature of an environment, based on brightness and another color temperature according to an embodiment of the disclosure;

FIG. 11 is a block diagram of an electronic device in a network environment according to an embodiment of the disclosure; and

FIG. 12 is a block diagram of a display module according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

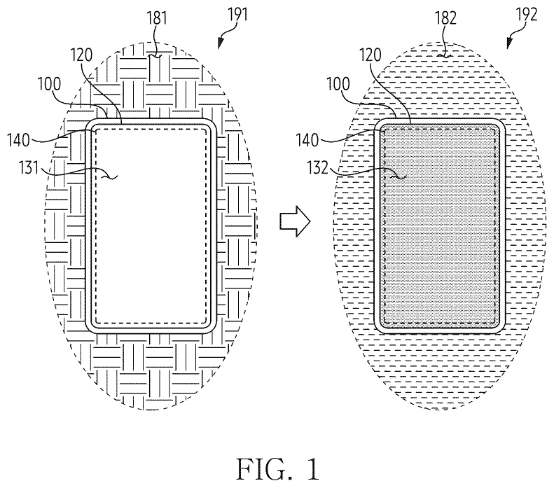

An electronic device may include a display. The display may be used for displaying a screen. For example, since the display is exposed to an environment around the electronic device, a visual quality of the screen may vary according to a change in the environment. For example, the screen may be viewable differently according to a color temperature of the environment. For example, since the screen is viewed differently according to a color temperature of the environment, the electronic device may set a color temperature of the screen, based on the color temperature of the environment. For example, the electronic device may change a color temperature of the screen based on a change in a color temperature of the environment. Changing a color temperature of the screen is exemplified in a description of FIG. 1.

FIG. 1 illustrates an example of changing a color temperature of a screen displayed on a display of an electronic device based on a change in a color temperature of an environment around the electronic device according to an embodiment of the disclosure.

Referring to FIG. 1, an electronic device 100 may display, on a display 120, a screen 140 having a first color temperature 131, as in a state 191. For example, the first color temperature 131 of the screen 140 may be set, identified, or provided based on a color temperature 181 of an environment around the electronic device 100.

For example, a color temperature of the environment may be changed. For example, the color temperature of the environment may be changed from the color temperature 181 to a color temperature 182. Maintaining a color temperature of the screen 140 as a first color temperature 131 corresponding to the color temperature 181 in the environment having the color temperature 182 may reduce a visual quality of the screen 140. For example, the electronic device 100 may change the state 191 to a state 192 according to a change from the color temperature 181 to the color temperature 182 for the visual quality of the screen 140. For example, as in the state 192, the electronic device 100 may display, on the display 120, the screen 140 having a second color temperature 132 changed from the first color temperature 131, according to the color temperature 182 changed from the color temperature 181, for the visual quality of the screen 140. For example, the second color temperature 132 of the screen 140 may be set, identified, or provided based on the color temperature 182 of the environment.

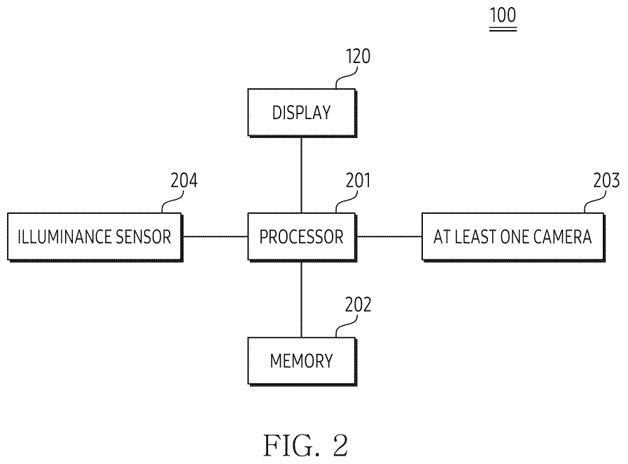

As described above, the electronic device 100 may execute operations for recognizing, identifying, or measuring a change from the color temperature 181 to the color temperature 182 for a change from the first color temperature 131 to the second color temperature 132. The electronic device 100 may include components for the operations. The components are exemplified in a description of FIG. 2.

FIG. 2 is a simplified block diagram of an electronic device according to an embodiment of the disclosure.

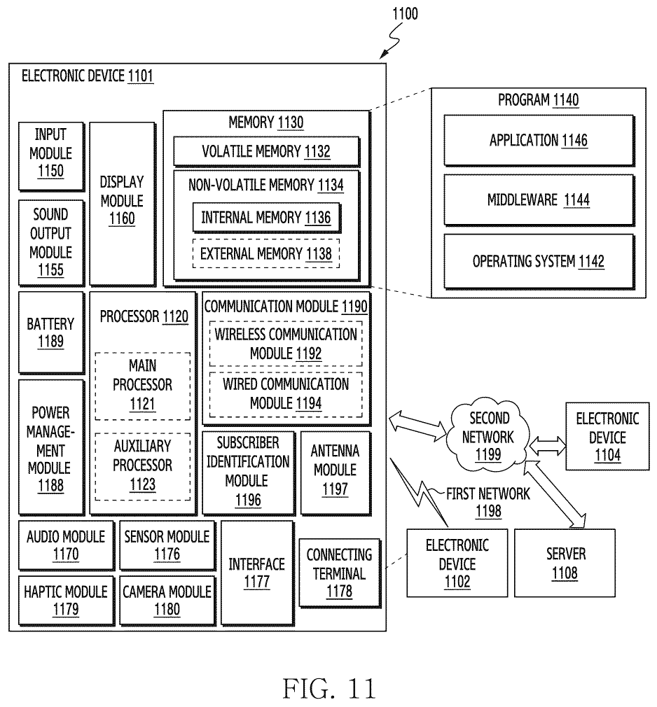

Referring to FIG. 2, an electronic device 100 may include at least a portion of an electronic device 1101 of FIG. 11 or may correspond to at least a portion of the electronic device 1101 of FIG. 11. The electronic device 100 may include a display 120, a processor 201, memory 202, at least one camera 203, and an illuminance sensor 204.

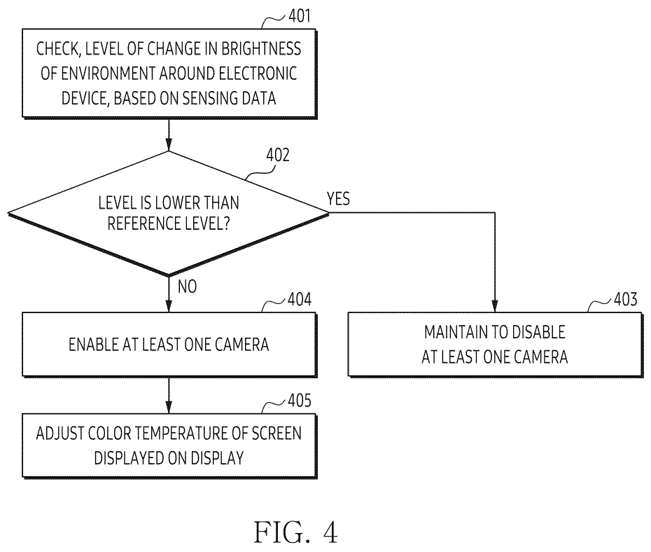

The processor 201 may include at least a portion of a processor 1120 of FIG. 11 or may correspond to at least a portion of the processor 1120 of FIG. 11. The processor 201 may be used to control the display 120, the memory 202, the at least one camera 203, and the illuminance sensor 204. The processor 201 may be configured to cause the electronic device 100 to execute at least a portion of operations exemplified in descriptions of FIGS. 4 to 10 below.

For example, the processor 201 may include a central processing unit (CPU) (or central processing circuitry). For example, the processor 201 may include a display processing unit (DPU) (or display control circuitry) for the display 120. For example, the processor 201 may include a memory controller for the memory 202 (e.g., volatile memory) and/or a storage controller for the memory 202 (e.g., non-volatile memory). For example, the processor 201 may include an image signal processor (ISP) (or camera control circuitry) (or image sensor control circuitry) for the at least one camera 203. For example, the processor 201 may include a sensor interface (or sensor hub) (or sensor control circuitry) for the illuminance sensor 204.

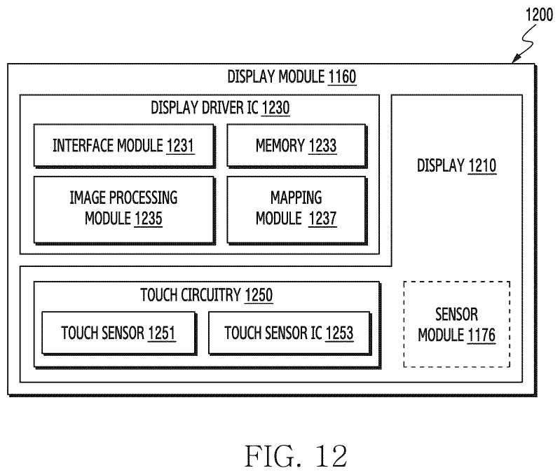

The display 120 may include at least a portion of a display module 1160 of FIGS. 11 and 12 or may correspond to at least a portion of the display module 1160 of FIGS. 11 and 12. The display 120 may be used for displaying a screen (e.g., visual information, visual data, and/or an image). For example, the display 120 may be used for displaying the screen obtained (or generated) (or rendered) by the processor 201. For example, the display 120 may be used for displaying the screen provided from the processor 201.

Although not illustrated in FIG. 2, the display 120 may include display driver circuitry (e.g., the display driver IC (DDI) 1230 of FIG. 12) and a display panel (e.g., the display 1210 of FIG. 12). For example, the display driver circuitry may be used to display the screen on the display panel. As a non-limiting example, the display driver circuitry may include memory (e.g., graphic random access memory (GRAM)) configured to store information regarding at least a portion of the screen. As a non-limiting example, the display driver circuitry may not include the memory. As a non-limiting example, the display driver circuitry may be configured to operate for a command mode of a display serial interface (DSI) and/or a video mode of the DSI. As a non-limiting example, the display driver circuitry may be configured to execute at least a portion of operations exemplified in descriptions of FIGS. 4 to 10 below. For example, a portion of operations of the processor 201 exemplified in descriptions of FIGS. 4 to 10 may be replaced with at least one operation of the display driver circuitry. For example, the display driver circuitry may adjust, set, or provide a color temperature of a screen displayed on the display panel based on control data (e.g., control command) from the processor 201.

The memory 202 may include at least a portion of memory 1130 of FIG. 11 or may correspond to at least a portion of the memory 1130 of FIG. 11. The memory 202 may be configured to store instructions causing the electronic device 100 to execute at least a portion of operations exemplified in descriptions of FIGS. 4 to 10 below.

The memory 202 may include non-volatile memory (e.g., non-volatile memory 1134 of FIG. 11). As a non-limiting example, the memory 202 may further include volatile memory (e.g., volatile memory 1132 of FIG. 11).

The at least one camera 203 may include at least a portion of a camera module 1180 of FIG. 11 or may correspond to at least a portion of the camera module 1180 of FIG. 11.

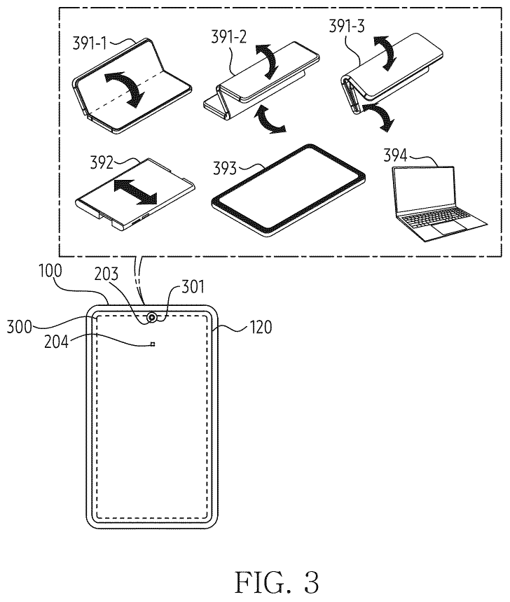

The at least one camera 203 may be used to obtain an image (e.g., a still image and/or a moving image (or video)). As a non-limiting example, the at least one camera 203 may include a camera including a telephoto lens and/or a camera including a wide-angle lens. As a non-limiting example, the at least one camera 203 may include a camera (e.g., selfie camera) facing a direction in which the display 120 (or the display panel) faces, among a plurality of cameras included in the electronic device 100. The camera facing a direction in which the display 120 faces will be exemplified in a description of FIG. 3.

For example, the at least one camera 203 may be used to recognize, measure, or identify a color temperature of the environment around the electronic device 100.

The illuminance sensor 204 may include at least a portion of a sensor module 1176 of FIG. 11 or may correspond to at least a portion of the sensor module 1176 of FIG. 11.

The illuminance sensor 204 may be used to obtain sensing data on brightness (or illuminance) of the environment around the electronic device 100. As a non-limiting example, the illuminance sensor 204 may be a sensor that does not have an ability to obtain sensing data for a color temperature of the environment. As a non-limiting example, a quality (or accuracy) of sensing data for a color temperature of the environment obtained by the illuminance sensor 204 may be lower than a quality (or accuracy) of sensing data for a color temperature of the environment obtained by the at least one camera 203. For example, the illuminance sensor 204 may be located under an active area of the display 120 (or the display panel). The illuminance sensor 204 located (or disposed) under the active area will be exemplified in a description of FIG. 3.

FIG. 3 illustrates an example of at least one camera, an illuminance sensor, and a display according to an embodiment of the disclosure.

Referring to FIG. 3, an electronic device 100 may include a display 120 having an active area including pixels available for displaying a screen. For example, at least a portion 300 of the active area may be visible from a front side of the electronic device 100.

For example, the illuminance sensor 204 may be located or disposed under at least a portion 300 of the active area. For example, the illuminance sensor 204 under at least a portion 300 of the active area may be configured to obtain sensing data on brightness of the environment based on light from outside.

As a non-limiting example, the display 120 may include a non-active area 301 visible from a front side of the electronic device 100. For example, the non-active area 301 may include pixels in which emitting light is disabled.

As a non-limiting example, the at least one camera 203 may be aligned with the non-active area 301. As a non-limiting example, the at least one camera 203 may be located under an opening (not illustrated in FIG. 3) located in the non-active area 301.

FIG. 3 illustrates the at least one camera 203 aligned with the non-active area 301. The at least one camera 203 may be located or disposed under at least a portion 300 of the active area, unlike the illustration of FIG. 3, like the illuminance sensor 204. As a non-limiting example, a density of pixels located over the at least one camera 203 may be relatively low for a quality of an image obtained through the at least one camera 203.

The arrangement of the at least one camera 203 and the illuminance sensor 204 exemplified in FIG. 3 may be applied not only to a bar-type smartphone (e.g., the electronic device 100 of FIG. 3) but also to other types of mobile devices. For example, the other types of the mobile devices may include a foldable-type device (e.g., a foldable smartphone 391-1, a multi-foldable smartphone 391-2, or a multi-foldable smartphone 391-3), a slidable (or rollable) type device 392, a tablet 393, and/or a laptop computer 394.

For example, the electronic device 100 may adaptively adjust a color temperature of a screen displayed on the display 120, in response to a change in a color temperature of the environment around the electronic device 100, by using the components exemplified in the description of FIG. 2. For example, enabling the at least one camera 203 may be executed in the electronic device 100 to adjust a color temperature of the screen according to a color temperature of the environment. Enabling the at least one camera 203 to adjust a color temperature of the screen according to a color temperature of the environment is exemplified in a description of FIG. 4.

FIG. 4 is a flowchart illustrating a method of enabling at least one camera to adjust a color temperature of a screen according to a color temperature of an environment according to an embodiment of the disclosure.

Referring to FIG. 4, in operation 401, the processor 201 may check, identify, recognize, measure, or obtain a level of a change in brightness of an environment around the electronic device 100, based on sensing data obtained by using the illuminance sensor 204, while a screen (e.g., the screen 140) is displayed on the display 120 and the at least one camera 203 is disabled.

For example, disabling the at least one camera 203 may include disabling (or ceasing) obtaining an image through the at least one camera 203. For example, disabling the at least one camera 203 may include not executing, in the electronic device 100, obtaining an image through the at least one camera 203. For example, disabling the at least one camera 203 may include disabling receiving light from outside through the at least one camera 203. For example, disabling the at least one camera 203 may include that a service provided by using the at least one camera 203 is disabled in the electronic device 100. As a non-limiting example, displaying a screen in a state of disabling the at least one camera 203 may include displaying a screen obtained without using the at least one camera 203.

For example, the sensing data may indicate brightness (or illuminance) of the environment. As a non-limiting example, a level of a change in the brightness may indicate a difference between first sensing data received through the illuminance sensor 204 within a first time interval and second sensing data received through the illuminance sensor 204 within a second time interval before the first time interval.

In operation 402, the processor 201 may check, determine, or identify whether the level checked in operation 401 is lower than a reference level.

For example, the processor 201 may check whether the checked level is lower than the reference level by comparing the reference level and the checked level. For example, since a color temperature of the environment may be changed according to a rapid change in the brightness of the environment, the processor 201 may check whether the checked level is lower than the reference level.

For example, the processor 201 may execute operation 403 in a condition that the checked level is lower than the reference level, and otherwise may execute operation 404.

Operation 402 of FIG. 4 is one of several possible operations. For example, operation 402 may be replaced with another operation for checking whether the brightness of the environment changes rapidly.

In operation 403, the processor 201 may maintain to disable the at least one camera 203 based on the level lower than the reference level. For example, since the level being lower than the reference level may indicate that the color temperature of the environment is maintained, the processor 201 may maintain to disable the at least one camera 203. As a non-limiting example, maintaining to disable the at least one camera 203 may be executed to reduce power consumed for adaptively adjusting a color temperature of the screen displayed on the display 120.

For example, the processor 201 may execute operation 401 and operation 402, while maintaining to disable the at least one camera 203. For example, the processor 201 may maintain checking the level and checking whether the level is lower than the reference level, while maintaining to disable the at least one camera 203.

The processor 201 may enable the at least one camera 203 in operation 404 based on the level higher than or equal to the reference level. For example, the at least one camera 203 may be enabled to recognize, measure, identify, or obtain a color temperature of the environment.

For example, since enabling the at least one camera 203 in operation 404 is executed to recognize (or measure) a color temperature of the environment around the electronic device 100, displaying a preview image based at least in part on at least a portion of images obtained through the at least one camera 203 while enabling the at least one camera 203 in operation 404 may be bypassed, omitted, refrained from, or not provided. As a non-limiting example, enabling the at least one camera 203 in operation 404 may be unnoticeable or transparent to a user. As a non-limiting example, enabling the at least one camera 203 in operation 404 may be indicated by an indication (e.g., a circle having a designated (or predetermined) color) in an indicator area displayed together with the screen.

In operation 405, the processor 201 may adjust a color temperature of the screen displayed on the display 120, according to a color temperature of the environment recognized by using the enabled at least one camera 203 according to operation 404.

For example, the processor 201 may obtain data on a color temperature of the environment through the enabled at least one camera 203 according to operation 404. For example, the data may be obtained by a component of the at least one camera 203 used for auto white balance (AWB) and/or a component (e.g., the ISP exemplified in the description of FIG. 2) of the processor 201. For example, the processor 201 may adjust a color temperature of the screen, based on the obtained data.

For example, the processor 201 may disable the at least one camera 203 after executing operation 405. For example, the processor 201 may disable the at least one camera 203 after obtaining the color temperature of the environment according to operation 404. For example, the processor 201 may execute operation 401 and operation 402 after operation 404 (and/or operation 405) is executed. For example, the processor 201 may disable the at least one camera 203 while maintaining checking the level and checking whether the level is lower than the reference level, after operation 404 (and/or operation 405) is executed.

Operation 405 of FIG. 4 illustrates adjusting the color temperature of the screen according to the color temperature of the environment. For example, the processor 201 may set the color temperature of the screen according to the color temperature of the environment. For example, in a case that the color temperature of the environment is maintained (or not changed) despite a rapid change in brightness of the environment, the processor 201 may maintain the color temperature of the screen.

As a non-limiting example, in order to reduce power consumption of the electronic device 100 including a rechargeable battery, the processor 201 may set a time enabling the at least one camera 203 to adjust the color temperature of the screen according to a change in the color temperature of the environment.

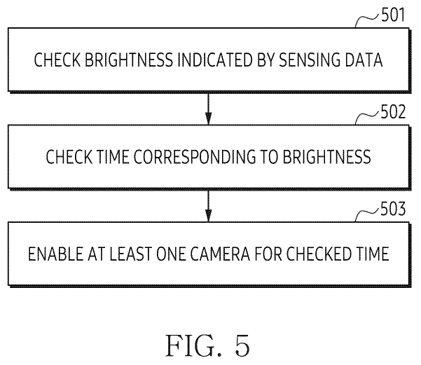

For example, the processor 201 may set a time enabling the at least one camera 203 to adjust the color temperature of the screen according to the color temperature of the environment, based at least in part on brightness of the environment indicated by the sensing data obtained through the illuminance sensor 204. Setting the time enabling the at least one camera 203 based at least in part on the brightness of the environment is exemplified in a description of FIG. 5.

FIG. 5 is a flowchart illustrating a method of setting a time enabling at least one camera according to brightness of an environment according to an embodiment of the disclosure.

Referring to FIG. 5, in operation 501, the processor 201 may check brightness of the environment indicated by sensing data obtained by using the illuminance sensor 204. For example, the sensing data may correspond to the sensing data exemplified in operation 401. For example, the sensing data may be different from the sensing data exemplified in operation 401. For example, the sensing data may be sensing data obtained by using the illuminance sensor 204 after operation 401 or operation 402 is executed.

In operation 502, the processor 201 may check a time corresponding to the brightness checked in operation 501 as a time enabling the at least one camera 203 to adjust the color temperature of the screen according to the color temperature of the environment.

For example, measuring a color temperature by using the at least one camera 203 may be inaccurate or unstable until a reference time (or a certain time) elapses from a timing enabling the at least one camera 203 according to operation 404. For example, a color temperature recognized or measured during the reference time (or the certain time) from the timing enabling the at least one camera 203 according to operation 404 may be changed even though the color temperature of the environment is maintained. For example, a color temperature recognized or measured during the reference time from the timing enabling the at least one camera 203 according to operation 404 may not reflect the color temperature of the environment. For example, a color temperature recognized or measured by using the at least one camera 203 may converge after the reference time elapses from the timing enabling the at least one camera 203 according to operation 404.

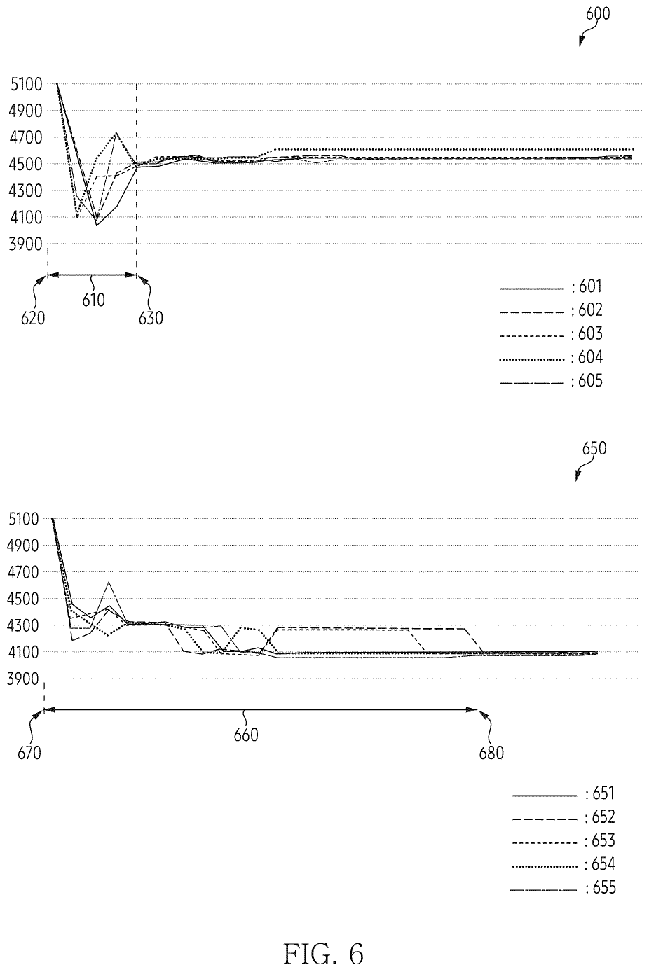

For example, the reference time may vary according to the brightness of the environment around the electronic device 100. The reference time varying according to the brightness is exemplified in a description of FIG. 6.

FIG. 6 is a chart illustrating a change in a color temperature measured by using at least one camera according to an embodiment of the disclosure.

Referring to FIG. 6, a horizontal axis of each of a chart 600 and a chart 650 indicates time, and a vertical axis of each of the chart 600 and the chart 650 indicates a color temperature.

Each of lines 601, 602, 603, 604 and 605 in the chart 600 indicates a change in a color temperature measured (or recognized) by using the at least one camera 203 in a state in which the brightness of the environment is A (e.g., 800 (lux)). For example, measuring a color temperature by using the at least one camera 203 during a reference time 610 from a timing 620 enabling the at least one camera 203 may be unstable, as indicated by lines 601 to 605. For example, measuring a color temperature by using the at least one camera 203 after the reference time 610 elapses from the timing 620 may be stable, as indicated by lines 601 to 605. For example, a color temperature measured by using the at least one camera 203 in a state in which the brightness is A may converge from a timing 630.

Each of lines 651, 652, 653, 654 and 655 in the chart 650 indicates a change in a color temperature measured (or recognized) by using the at least one camera 203 in a state in which the brightness of the environment is B (e.g., 100 (lux)). For example, measuring a color temperature by using the at least one camera 203 during a reference time 660 from a timing 670 enabling the at least one camera 203 may be unstable, as indicated by lines 651 to 655. For example, measuring a color temperature by using the at least one camera 203 after the reference time 660 elapses from the timing 670 may be stable, as indicated by lines 651 to 655. For example, a color temperature measured by using the at least one camera 203 in a state in which the brightness is B may converge from a timing 680. For example, a reference time at which a color temperature measured by using the at least one camera 203 converges may vary according to the brightness (e.g., A or B), as indicated by the reference time 610 and the reference time 660 longer than the reference time 610.

Referring back to FIG. 5, since the reference time varies according to the brightness of the environment, the processor 201 may set a time enabling the at least one camera 203 to adjust the color temperature of the screen according to the color temperature of the environment, based at least in part on the brightness. For example, the processor 201 may set the time as a first time based on the brightness within a first reference range, and may set the time as a second time different from the first time based on the brightness within a second reference range not overlapping the first reference range.

As a non-limiting example, the electronic device 100 may store, in the non-volatile memory exemplified in the description of FIG. 2, reference data including the first time defined for the brightness within the first reference range and the second time defined for the brightness within the second reference range. For example, the processor 201 may check a time corresponding to the brightness checked in operation 501 from the reference data and may set the checked time as a time enabling the at least one camera 203.

In operation 503, the processor 201 may enable the at least one camera 203 for the time checked in operation 502 to adjust the color temperature of the screen according to the color temperature of the environment.

For example, the processor 201 may enable the at least one camera 203 for the first time to adjust the color temperature of the screen according to the color temperature of the environment, based on the brightness within the first reference range. For example, the processor 201 may enable the at least one camera 203 for the second time to adjust the color temperature of the screen according to the color temperature of the environment, based on the brightness within the second reference range. For example, the processor 201 may set a timing obtaining data on the color temperature of the environment available for adjusting the color temperature of the screen, based at least in part on the brightness indicated by the sensing data exemplified in operation 501.

As described above, the electronic device 100 may reduce power consumed for adjusting the color temperature of the screen according to the color temperature of the environment, by setting a time enabling the at least one camera 203 based on the brightness.

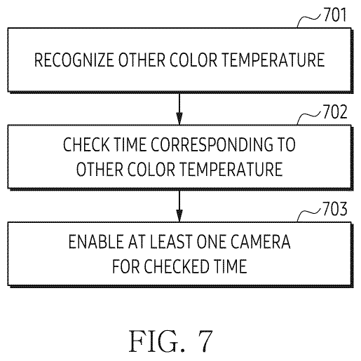

Referring back to FIG. 4, the processor 201 may recognize (or measure) another color temperature of the environment, before recognizing (or measuring) the color temperature of the environment to adjust the color temperature of the screen. For example, the other color temperature of the environment may be recognized or measured to set a time enabling the at least one camera 203 to adjust the color temperature of the screen. Setting the time enabling the at least one camera 203 based on the other color temperature is exemplified in a description of FIG. 7.

FIG. 7 is a flowchart illustrating a method of setting a time enabling at least one camera according to another color temperature according to an embodiment of the disclosure.

Referring to FIG. 7, in operation 701, the processor 201 may recognize, measure, or obtain the other color temperature of the environment by using the enabled at least one camera 203 according to operation 404. For example, the other color temperature of the environment may be recognized before recognizing the color temperature of the screen. For example, the other color temperature of the environment may be recognized after a predetermined time elapses from a timing enabling the at least one camera 203. For example, the other color temperature of the environment may be the same as the color temperature of the screen or may be different from the color temperature of the screen.

In operation 702, the processor 201 may check a time corresponding to the other color temperature recognized in operation 701 as a time enabling the at least one camera 203 to adjust the color temperature of the screen according to the color temperature of the environment.

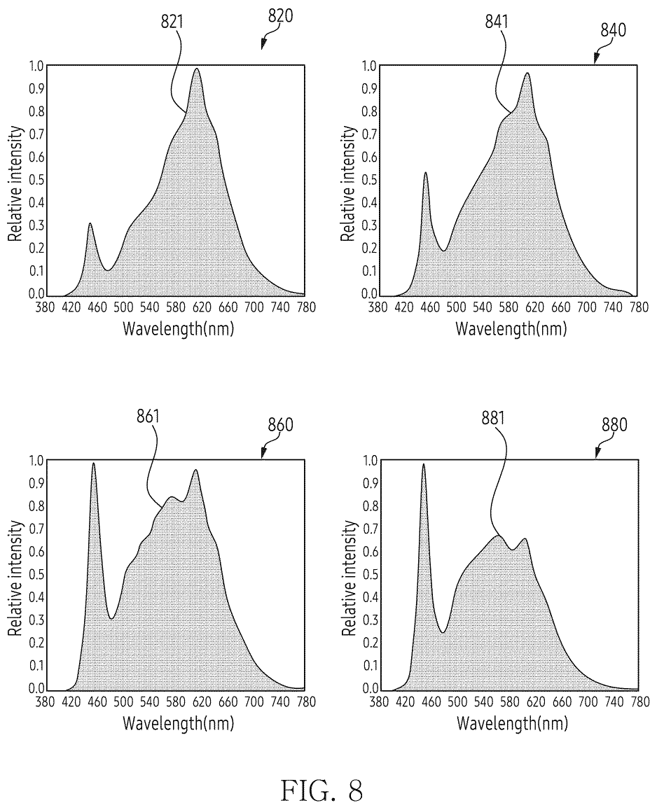

For example, a time at which a color temperature measured by using the at least one camera 203 converges may vary according to a distribution of a power spectrum of light from the environment (or (actual) color temperature of the environment). The distribution of the power spectrum is exemplified in a description of FIG. 8.

FIG. 8 is a chart illustrating a distribution of colors according to color temperature according to an embodiment of the disclosure.

Referring to FIG. 8, a horizontal axis of each of a chart 820, a chart 840, a chart 860, and a chart 880 indicates a wavelength, and a vertical axis of each of the chart 820, the chart 840, the chart 860, and the chart 880 indicates a relative density.

For example, a line 821 in the chart 820 may indicate a wavelength-specific distribution of light from an environment in which a color temperature (or actual color temperature) is A (e.g., 2700 kelvin (K)) (e.g., light from a white light-emitting diode (LED)), a line 841 in the chart 840 may indicate a wavelength-specific distribution of light from an environment in which a color temperature (or actual color temperature) is B (e.g., 3000 (K)) (e.g., light from a white LED), a line 861 in the chart 860 may indicate a wavelength-specific distribution of light from an environment in which a color temperature (or actual color temperature) is C (e.g., 4000 (K)) (e.g., light from a white LED), and a line 881 in the chart 880 may indicate a wavelength-specific distribution of light from an environment in which a color temperature (or actual color temperature) is D (e.g., 5000 (K)) (e.g., light from a white LED).

For example, since the at least one camera 203 includes a color filter having a Bayer pattern, a Tetra pattern, or a Nona pattern, a first sensitivity of the at least one camera 203 to a green light component may be higher than a second sensitivity of the at least one camera 203 to each of other light components (e.g., a red light component and a blue light component). For example, a time at which a color temperature measured by using the at least one camera 203 converges when a color temperature (or actual color temperature) of the environment is C may be shorter than a time at which a color temperature measured by using the at least one camera 203 converges when a color temperature (or actual color temperature) of the environment is A, B, or D, due to the first sensitivity higher than the second sensitivity.

Referring back to FIG. 7, since the time at which a color temperature measured by using the at least one camera 203 converges varies according to a distribution of a power spectrum of light from the environment (or (actual) color temperature of the environment), the processor 201 may set a time enabling the at least one camera 203 based at least in part on the other color temperature. For example, the processor 201 may set, as a first time, a time enabling the at least one camera 203 to adjust the color temperature of the screen based on the other color temperature within a first reference range, and may set, as a second time, a time enabling the at least one camera 203 to adjust the color temperature of the screen based on the other color temperature within a second reference range not overlapping the first reference range.

As a non-limiting example, the electronic device 100 may store, in the non-volatile memory exemplified in the description of FIG. 2, reference data including the first time defined for the other color temperature within the first reference range and the second time defined for the other color temperature within the second reference range. For example, the processor 201 may check a time corresponding to the other color temperature recognized in operation 701 from the reference data, and may set the checked time as a time enabling the at least one camera 203.

In operation 703, the processor 201 may enable the at least one camera 203 for the time checked in operation 702 to adjust the color temperature of the screen.

For example, the processor 201 may enable the at least one camera 203 for the first time to adjust the color temperature of the screen, based on the other color temperature within the first reference range. For example, the processor 201 may enable the at least one camera 203 for the second time to adjust the color temperature of the screen, based on the other color temperature within the second reference range. For example, the processor 201 may set a timing obtaining data on the color temperature of the environment, based at least in part on the other color temperature.

As described above, the electronic device 100 may reduce power consumed for adjusting the color temperature of the screen, by setting a time enabling the at least one camera 203 based on the other color temperature.

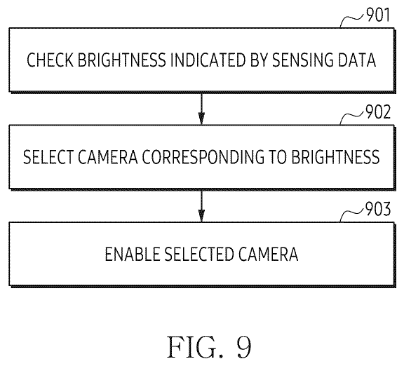

Referring back to FIG. 4, the at least one camera 203 may include a first camera and a second camera having angle of view (AOV) different from AOV of the first camera. For example, the processor 201 may select, identify, or determine, among the first camera and the second camera, a camera to be enabled to adjust the color temperature of the screen, based at least in part on brightness of the environment indicated by the sensing data from the illuminance sensor 204. Selecting the camera to be enabled to adjust the color temperature of the screen is exemplified in a description of FIG. 9.

FIG. 9 is a flowchart illustrating a method of selecting a camera used for adjusting a color temperature of a screen according to brightness of an environment according to an embodiment of the disclosure.

Referring to FIG. 9, in operation 901, the processor 201 may check brightness indicated by sensing data obtained by using the illuminance sensor 204. For example, operation 901 may correspond to operation 501 of FIG. 5.

In operation 902, the processor 201 may select, among the first camera and the second camera, a camera corresponding to the brightness checked in operation 901.

For example, the AOV of the first camera may be wider than the AOV of the second camera. For example, a F-number of the first camera may be smaller than a F-number of the second camera. For example, the number of pixels of an image sensor in the first camera may be greater than the number of pixels of an image sensor in the second camera. For example, power consumed per unit time according to enabling the first camera may be greater than power consumed per unit time according to enabling the second camera, due to a difference between the number of pixels of the image sensor in the first camera and the number of pixels of the image sensor in the second camera.

For example, power consumed according to enabling the first camera to adjust the color temperature of the screen in a condition in which the brightness is higher than a reference brightness (or certain brightness) may be greater than power consumed according to enabling the second camera to adjust the color temperature of the screen in a condition in which the brightness is higher than the reference brightness. For example, since the brightness being higher than the reference brightness (or certain brightness) may indicate that a sufficient amount of light can be received through the second camera despite the F-number of the second camera being greater than the F-number of the first camera, the processor 201 may select, among the first camera and the second camera, the second camera as a camera for adjusting the color temperature of the screen to reduce power consumption in a condition in which the brightness is higher than the reference brightness.

As another example, since the F-number of the first camera is smaller than the F-number of the second camera, a time at which a color temperature measured (or recognized) by using the first camera converges may be shorter than a time at which a color temperature measured (or recognized) by using the second camera converges. For example, since the brightness being lower than the reference brightness (or certain brightness) may indicate that a sufficient amount of light cannot be received through the second camera due to the F-number of the second camera being greater than the F-number of the first camera, the processor 201 may select, among the first camera and the second camera, the first camera as a camera for adjusting the color temperature of the screen to reduce a time enabling a camera, in a condition in which the brightness is lower than the reference brightness.

As described above, since enabling the first camera to adjust the color temperature of the screen and enabling the second camera to adjust the color temperature of the screen may vary according to the brightness, the processor 201 may select a camera used to adjust the color temperature of the screen based at least in part on the brightness. For example, the selection may be executed based on a F-number of a camera. For example, the selection may be executed based on AOV of a camera.

For example, the processor 201 may select, among the first camera and the second camera, the first camera as a camera for adjusting the color temperature of the screen based on the brightness within the first reference range. For example, the processor 201 may select, among the first camera and the second camera, the second camera as a camera for adjusting the color temperature of the screen based on the brightness within a second reference range not overlapping the first reference range (e.g., a minimum brightness value of the second reference range is higher than a maximum brightness value of the first reference range).

In operation 903, the processor 201 may enable a camera selected in operation 902 to adjust the color temperature of the screen. For example, the processor 201 may enable, among the first camera and the second camera, the first camera to adjust the color temperature of the screen, based on the brightness within the first reference range. For example, the processor 201 may enable, among the first camera and the second camera, the second camera to adjust the color temperature of the screen based on the brightness within the second reference range.

As described above, the electronic device 100 may reduce power consumed for adjusting the color temperature of the screen by selecting a camera based on the brightness.

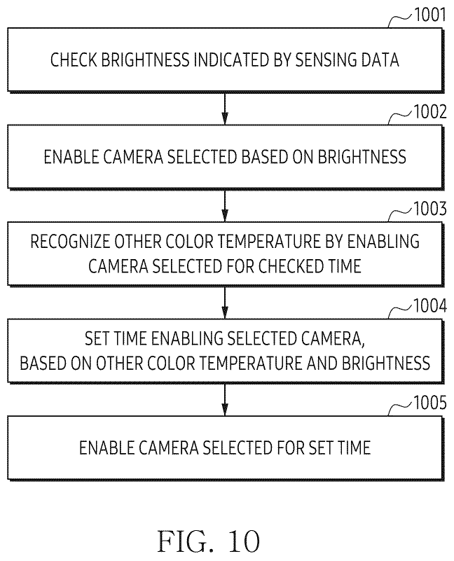

For example, operations exemplified in the descriptions of FIGS. 5 to 9 may be combined with each other. The combination of the operations is exemplified in a description of FIG. 10.

FIG. 10 is a flowchart illustrating a method of enabling at least one camera to adjust a color temperature of a screen according to a color temperature of an environment, based on brightness and another color temperature according to an embodiment of the disclosure.

Referring to FIG. 10, in operation 1001, the processor 201 may check brightness indicated by sensing data obtained through the illuminance sensor 204. For example, operation 1001 may correspond to operation 501 of FIG. 5 or operation 901 of FIG. 9.

In operation 1002, the processor 201 may enable a camera selected based on the brightness checked in operation 1001. For example, operation 1002 may correspond to operations 902 and 903 of FIG. 9.

In operation 1003, the processor 201 may recognize another color temperature of the environment around the electronic device 100 by enabling the camera selected in operation 1002. For example, operation 1003 may correspond to operation 701 of FIG. 7.

In operation 1004, the processor 201 may set a time enabling the camera selected in operation 1002, based on the other color temperature recognized in operation 1003 and the brightness checked in operation 1001. For example, the time may be set according to methods exemplified in the descriptions of operation 502 of FIG. 5 and operation 702 of FIG. 7.

In operation 1005, the processor 201 may enable the camera selected in operation 1002 for a time set in operation 1004 to adjust the color temperature of the screen.

As described above, the electronic device 100 may reduce power consumed for adjusting the color temperature of the screen, by selecting a camera based on the brightness and setting a time enabling the selected camera based on the brightness and the other color temperature.

The operations exemplified above may be caused by the electronic device 1101 exemplified in a description of FIG. 11. For example, the electronic device 1101 may include the display module 1160 exemplified in a description of FIG. 12.

FIG. 11 is a block diagram illustrating an electronic device 1101 in a network environment 1100 according to an embodiment of the disclosure.

Referring to FIG. 11, the electronic device 1101 in the network environment 1100 may communicate with an electronic device 1102 via a first network 1198 (e.g., a short-range wireless communication network), or at least one of an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module(SIM) 1196, or an antenna module 1197. In some embodiments, at least one of the components (e.g., the connecting terminal 1178) may be omitted from the electronic device 1101, or one or more other components may be added in the electronic device 1101. In some embodiments, some of the components (e.g., the sensor module 1176, the camera module 1180, or the antenna module 1197) may be implemented as a single component (e.g., the display module 1160).

The processor 1120 may execute, for example, software (e.g., a program 1140) to control at least one other component (e.g., a hardware or software component) of the electronic device 1101 coupled with the processor 1120, and may perform various data processing or computation. According to an embodiment, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134. According to an embodiment, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with, the main processor 1121. For example, when the electronic device 1101 includes the main processor 1121 and the auxiliary processor 1123, the auxiliary processor 1123 may be adapted to consume less power than the main processor 1121, or to be specific to a specified function. The auxiliary processor 1123 may be implemented as separate from, or as part of the main processor 1121.

The auxiliary processor 1123 may control at least some of functions or states related to at least one component (e.g., the display module 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). According to an embodiment, the auxiliary processor 1123 (e.g., an image signal processor or a communication processor) may be implemented as part of another component (e.g., the camera module 1180 or the communication module 1190) functionally related to the auxiliary processor 1123. According to an embodiment, the auxiliary processor 1123 (e.g., the neural processing unit) may include a hardware structure specified for artificial intelligence model processing. An artificial intelligence model may be generated by machine learning. Such learning may be performed, e.g., by the electronic device 1101 where the artificial intelligence is performed or via a separate server (e.g., the server 1108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by another component (e.g., the processor 1120) of the electronic device 1101, from the outside (e.g., a user) of the electronic device 1101. The input module 1150 may include, for example, a microphone, a mouse, a keyboard, a key (e.g., a button), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1160 may visually provide information to the outside (e.g., a user) of the electronic device 1101. The display module 1160 may include, for example, a display, a hologram device, or a projector and control circuitry to control a corresponding one of the display, hologram device, and projector. According to an embodiment, the display module 1160 may include a touch sensor adapted to detect a touch, or a pressure sensor adapted to measure the intensity of force incurred by the touch.

The audio module 1170 may convert a sound into an electrical signal and vice versa. According to an embodiment, the audio module 1170 may obtain the sound via the input module 1150, or output the sound via the sound output module 1155 or a headphone of an external electronic device (e.g., an electronic device 1102) directly (e.g., wiredly) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the electronic device 1102) directly (e.g., wiredly) or wirelessly. According to an embodiment, the interface 1177 may include, for example, a high definition multimedia interface (HDMI), a universal serial bus (USB) interface, a secure digital (SD) card interface, or an audio interface.

A connecting terminal 1178 may include a connector via which the electronic device 1101 may be physically connected with the external electronic device (e.g., the electronic device 1102). According to an embodiment, the connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or electrical stimulus which may be recognized by a user via his tactile sensation or kinesthetic sensation. According to an embodiment, the haptic module 1179 may include, for example, a motor, a piezoelectric element, or an electric stimulator.

The camera module 1180 may capture a still image or moving images. According to an embodiment, the camera module 1180 may include one or more lenses, image sensors, image signal processors, or flashes.

The power management module 1188 may manage power supplied to the electronic device 1101. According to an embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the application processor (AP)) and supports a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., the mmWave band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 1164 dB or less) for implementing mMTC, or U-plane latency (e.g., 0.5 ms or less for each of downlink (DL) and uplink (UL), or a round trip of 11 ms or less) for implementing URLLC.

The antenna module 1197 may transmit or receive a signal or power to or from the outside (e.g., the external electronic device) of the electronic device 1101. According to an embodiment, the antenna module 1197 may include an antenna including a radiating element composed of a conductive material or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in the communication network, such as the first network 1198 or the second network 1199, may be selected, for example, by the communication module 1190 (e.g., the wireless communication module 1192) from the plurality of antennas. The signal or the power may then be transmitted or received between the communication module 1190 and the external electronic device via the selected at least one antenna. According to an embodiment, another component (e.g., a radio frequency integrated circuit (RFIC)) other than the radiating element may be additionally formed as part of the antenna module 1197.

According to various embodiments, the antenna module 1197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1101 and the external electronic device 1104 via the server 1108 coupled with the second network 1199. Each of the electronic devices 1102 or 1104 may be a device of a same type as, or a different type, from the electronic device 1101. According to an embodiment, all or some of operations to be executed at the electronic device 1101 may be executed at one or more of the external electronic devices 1102 or 1104, or the server 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, a cloud computing, distributed computing, mobile edge computing (MEC), or client-server computing technology may be used, for example. The electronic device 1101 may provide ultra low-latency services using, e.g., distributed computing or mobile edge computing. In another embodiment, the external electronic device 1104 may include an internet-of-things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on 5G communication technology or IoT-related technology.

FIG. 12 is a block diagram 1200 illustrating the display module 1160 according to an embodiment of the disclosure.

Referring to FIG. 12, the display module 1160 may include a display 1210 and a display driver integrated circuit (DDI) 1230 to control the display 1210. The DDI 1230 may include an interface module 1231, memory 1233 (e.g., buffer memory), an image processing module 1235, or a mapping module 1237. The DDI 1230 may receive image information that contains image data or an image control signal corresponding to a command to control the image data from another component of the electronic device 1101 via the interface module 1231. For example, according to an embodiment, the image information may be received from the processor 1120 (e.g., the main processor 1121 (e.g., an application processor)) or the auxiliary processor 1123 (e.g., a graphics processing unit) operated independently from the function of the main processor 1121. The DDI 1230 may communicate, for example, with touch circuitry 1250 or the sensor module 1176 via the interface module 1231. The DDI 1230 may also store at least part of the received image information in the memory 1233, for example, on a frame by frame basis. The image processing module 1235 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 1210. The mapping module 1237 may generate a voltage value or a current value corresponding to the image data pre-processed or post-processed by the image processing module 1235. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 1210 may be driven, for example, based at least in part on the voltage value or the current value such that visual information (e.g., a text, an image, or an icon) corresponding to the image data may be displayed via the display 1210.

According to an embodiment, the display module 1160 may further include the touch circuitry 1250. The touch circuitry 1250 may include a touch sensor 1251 and a touch sensor IC 1253 to control the touch sensor 1251. The touch sensor IC 1253 may control the touch sensor 1251 to sense a touch input or a hovering input with respect to a certain position on the display 1210. To achieve this, for example, the touch sensor 1251 may detect (e.g., measure) a change in a signal (e.g., a voltage, a quantity of light, a resistance, or a quantity of one or more electric charges) corresponding to the certain position on the display 1210. The touch circuitry 1250 may provide input information (e.g., a position, an area, a pressure, or a time) indicative of the touch input or the hovering input detected via the touch sensor 1251 to the processor 1120. According to an embodiment, at least part (e.g., the touch sensor IC 1253) of the touch circuitry 1250 may be formed as part of the display 1210 or the DDI 1230, or as part of another component (e.g., the auxiliary processor 1123) disposed outside the display module 1160.

According to an embodiment, the display module 1160 may further include at least one sensor (e.g., a fingerprint sensor, an iris sensor, a pressure sensor, or an illuminance sensor) of the sensor module 1176 or a control circuit for the at least one sensor. In such a case, the at least one sensor or the control circuit for the at least one sensor may be embedded in one portion of a component (e.g., the display 1210, the DDI 1230, or the touch circuitry 1250)) of the display module 1160. For example, when the sensor module 1176 embedded in the display module 1160 includes a biometric sensor (e.g., a fingerprint sensor), the biometric sensor may obtain biometric information (e.g., a fingerprint image) corresponding to a touch input received via a portion of the display 1210. As another example, when the sensor module 1176 embedded in the display module 1160 includes a pressure sensor, the pressure sensor may obtain pressure information corresponding to a touch input received via a partial or whole area of the display 1210. According to an embodiment, the touch sensor 1251 or the sensor module 1176 may be disposed between pixels in a pixel layer of the display 1210, or over or under the pixel layer.

As described above, an electronic device (e.g., the electronic device 100) may comprise memory (e.g., the memory 202) configured to store instructions, at least one camera (e.g., the at least one camera 203), an illuminance sensor (e.g., the illuminance sensor 204), a display (e.g., the display 120), and a processor (e.g., the processor 201). The processor may be configured to execute the instructions to cause the electronic device to check a level of a change of brightness of an environment around the electronic device based on sensing data obtained by using the illuminance sensor, while a screen is displayed on the display and the at least one camera is disabled, maintain to disable the at least one camera based on the level lower than a reference level, and based on the level higher than or equal to the reference level, enable the at least one camera, and adjust a color temperature of the screen displayed on the display, according to a color temperature of the environment recognized by using the enabled at least one camera.

For example, the illuminance sensor may be positioned under an active area of the display.

For example, the at least one camera may face a direction in which the display faces.

For example, the processor may be configured to execute the instructions to cause the electronic device to check whether the level is lower than the reference level, while the screen is displayed on the display and the at least one camera is disabled.

For example, the processor may be configured to execute the instructions to cause the electronic device to set time enabling the at least one camera to adjust the color temperature of the screen according to the color temperature of the environment, based at least in part on the brightness indicated by the sensing data.

For example, the processor may be configured to execute the instructions to cause the electronic device to check the brightness indicated by the sensing data, based on the brightness in a first reference range, enable, during first time, the at least one camera to adjust the color temperature of the screen according to the color temperature of the environment, and based on the brightness in a second reference range not overlapping the first reference range, enable, during second time different from the first time, the at least one camera to adjust the color temperature of the screen according to the color temperature of the environment.

For example, the processor may be configured to execute the instructions to cause the electronic device to recognize another color temperature of the environment by using the enabled at least one camera, before the color temperature of the environment used for adjusting the color temperature of the screen is recognized, and set time enabling the at least one camera to recognize the color temperature of the environment, based at least in part on the other color temperature.

For example, the processor may be configured to execute the instructions to cause the electronic device to recognize another color temperature of the environment by using the enabled at least one camera, before the color temperature of the environment used for adjusting the color temperature of the screen is recognized, based on the other color temperature in a first reference range, enable, during first time, the at least one camera to adjust the color temperature of the screen according to the color temperature of the environment, and based on the other color temperature in a second reference range not overlapping the first reference range, enable, during second time different from the first time, the at least one camera to adjust the color temperature of the screen according to the color temperature of the environment.

For example, the at least one camera may include a first camera and a second camera having angle of view (AOV) different from AOV of the first camera. For example, the processor may be configured to execute the instructions to cause the electronic device to select a camera enabled for adjusting the color temperature of the screen according to the color temperature of the environment from among the first camera and the second camera, based at least in part on the brightness indicated by the sensing data.

For example, the processor may be configured to execute the instructions to cause the electronic device to check the brightness indicated by the sensing data, based on the brightness in a first reference range, enable the first camera from among the first camera and the second camera to adjust the color temperature of the screen according to the color temperature of the environment, and based on the brightness in a second reference range not overlapping the first reference range, enable the second camera from among the first camera and the second camera to adjust the color temperature of the screen according to the color temperature of the environment.

For example, the color temperature of the environment may be recognized by a component of the at least one camera and a component of the at least one processor that are used for auto white balance (AWB).

For example, the processor may be configured to execute the instructions to cause the electronic device to set timing obtaining data on the color temperature of the environment, based at least in part on the brightness indicated by the sensing data.

For example, the processor may be configured to execute the instructions to cause the electronic device to recognize another color temperature of the environment by using the enabled at least one camera, before the color temperature of the environment used for adjusting the color temperature of the screen is recognized, and set timing obtaining data on the color temperature of the environment, based at least in part on the other color temperature.

As described above, a method may be executed in an electronic device with at least one camera, an illuminance sensor, and a display. The method may comprise checking a level of change of brightness of environment around the electronic device based on sensing data obtained by using the illuminance sensor, while a screen is displayed on the display and the at least one camera is disabled, based on the level lower than a reference level, maintaining to disable the at least one camera, and based on the level higher than or equal to the reference level, enabling the at least one camera, and adjusting a color temperature of the screen displayed on the display, according to color temperature of the environment recognized by using the enabled at least one camera.

For example, the method may comprise checking whether the level is lower than the reference level, while the screen is displayed on the display and the at least one camera is disabled.

For example, the method may comprise setting time enabling the at least one camera to adjust the color temperature of the screen according to the color temperature of the environment, based at least in part on the brightness indicated by the sensing data.

For example, the method may comprise recognizing another color temperature of the environment by using the enabled at least one camera, before the color temperature of the environment used for adjusting the color temperature of the screen is recognized, and setting time enabling the at least one camera to recognize the color temperature of the environment, based at least in part on the other color temperature.

For example, the method may comprise setting timing obtaining data on the color temperature of the environment, based at least in part on the brightness indicated by the sensing data.

For example, the method may comprise recognizing another color temperature of the environment by using the enabled at least one camera, before the color temperature of the environment used for adjusting the color temperature of the screen is recognized, and setting timing obtaining data on the color temperature of the environment, based at least in part on the other color temperature.

As described above, a non-transitory computer readable storage medium may store one or more programs. For example, the one or more programs may comprise instructions to, when executed by an electronic device with at least one camera, an illuminance sensor, and a display, cause the electronic device to check a level of change of brightness of environment around the electronic device based on sensing data obtained by using the illuminance sensor, while a screen is displayed on the display and the at least one camera is disabled, based on the level lower than a reference level, maintain to disable the at least one camera, and based on the level higher than or equal to the reference level, enable the at least one camera, and adjust a color temperature of the screen displayed on the display, according to color temperature of the environment recognized by using the enabled at least one camera.

The technical problems to be achieved in this document are not limited to those described above, and other technical problems not mentioned herein will be clearly understood by those having ordinary knowledge in the art to which the disclosure belongs, from the following description.

The effects that can be obtained from the disclosure are not limited to those described above, and any other effects not mentioned herein will be clearly understood by those having ordinary knowledge in the art to which the disclosure belongs, from the following description.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory comprising one or more storage media storing instructions;
at least one camera;
an illuminance sensor;
a display; and
at least one processor comprising processing circuitry,
wherein the instructions, when executed by the at least one processor individually or collectively, cause the electronic device to:
check a level of change of brightness of environment around the electronic device based on sensing data obtained by using the illuminance sensor, while a screen is displayed on the display and the at least one camera is disabled,
based on the level lower than a reference level, maintain to disable the at least one camera, and
based on the level higher than or equal to the reference level:
enable the at least one camera, and
adjust a color temperature of the screen displayed on the display, according to color temperature of the environment recognized by using the enabled at least one camera.

2. The electronic device of claim 1, wherein the illuminance sensor is positioned under an active area of the display.

3. The electronic device of claim 1, wherein the at least one camera faces a direction in which the display faces.

4. The electronic device of claim 1, wherein the instructions, when executed by the at least one processor individually or collectively, cause the electronic device to check whether the level is lower than the reference level, while the screen is displayed on the display and the at least one camera is disabled.

5. The electronic device of claim 1, wherein the instructions, when executed by the at least one processor individually or collectively, cause the electronic device to set time enabling the at least one camera to adjust the color temperature of the screen according to the color temperature of the environment, based at least in part on the brightness indicated by the sensing data.

6. The electronic device of claim 1, wherein the instructions, when executed by the at least one processor individually or collectively, cause the electronic device to:
check the brightness indicated by the sensing data,
based on the brightness in a first reference range, enable, during first time, the at least one camera to adjust the color temperature of the screen according to the color temperature of the environment, and
based on the brightness in a second reference range not overlapping the first reference range, enable, during second time different from the first time, the at least one camera to adjust the color temperature of the screen according to the color temperature of the environment.

7. The electronic device of claim 1, wherein the instructions, when executed by the at least one processor individually or collectively, cause the electronic device to:
recognize another color temperature of the environment by using the enabled at least one camera, before the color temperature of the environment used for adjusting the color temperature of the screen is recognized, and
set time enabling the at least one camera to recognize the color temperature of the environment, based at least in part on the other color temperature.

8. The electronic device of claim 1, wherein the instructions, when executed by the at least one processor individually or collectively, cause the electronic device to:
recognize another color temperature of the environment by using the enabled at least one camera, before the color temperature of the environment used for adjusting the color temperature of the screen is recognized,
based on the other color temperature in a first reference range, enable, during first time, the at least one camera to adjust the color temperature of the screen according to the color temperature of the environment, and
based on the other color temperature in a second reference range not overlapping the first reference range, enable, during second time different from the first time, the at least one camera to adjust the color temperature of the screen according to the color temperature of the environment.

9. The electronic device of claim 1,
wherein the at least one camera includes a first camera and a second camera having angle of view (AOV) different from AOV of the first camera, and
wherein the instructions, when executed by the at least one processor individually or collectively, cause the electronic device to select a camera enabled for adjusting the color temperature of the screen according to the color temperature of the environment from among the first camera and the second camera, based at least in part on the brightness indicated by the sensing data.

10. The electronic device of claim 1,
wherein the at least one camera includes a first camera and a second camera having angle of view (AOV) different from AOV of the first camera, and
wherein the instructions, when executed by the at least one processor individually or collectively, cause the electronic device to:
check the brightness indicated by the sensing data,
based on the brightness in a first reference range, enable the first camera from among the first camera and the second camera to adjust the color temperature of the screen according to the color temperature of the environment, and
based on the brightness in a second reference range not overlapping the first reference range, enable the second camera from among the first camera and the second camera to adjust the color temperature of the screen according to the color temperature of the environment.

11. The electronic device of claim 1, wherein the color temperature of the environment is recognized by a component of the at least one camera and a component of the at least one processor that are used for auto white balance (AWB).

12. The electronic device of claim 1, wherein the instructions, when executed by the at least one processor individually or collectively, cause the electronic device to set timing obtaining data on the color temperature of the environment, based at least in part on the brightness indicated by the sensing data.

13. The electronic device of claim 1, wherein the instructions, when executed by the at least one processor individually or collectively, cause the electronic device to:
recognize another color temperature of the environment by using the enabled at least one camera, before the color temperature of the environment used for adjusting the color temperature of the screen is recognized, and
set timing obtaining data on the color temperature of the environment, based at least in part on the other color temperature.

14. A method performed by an electronic device with at least one camera, an illuminance sensor, and a display, the method comprising:
checking, by the electronic device, a level of change of brightness of environment around the electronic device based on sensing data obtained by using the illuminance sensor, while a screen is displayed on the display and the at least one camera is disabled;
based on the level lower than a reference level, maintaining, by the electronic device, to disable the at least one camera; and
based on the level higher than or equal to the reference level:
enabling, by the electronic device, the at least one camera, and
adjusting, by the electronic device, a color temperature of the screen displayed on the display, according to color temperature of the environment recognized by using the enabled at least one camera.

15. The method of claim 14, further comprising:
checking whether the level is lower than the reference level, while the screen is displayed on the display and the at least one camera is disabled.

16. The method of claim 14, further comprising:
setting time enabling the at least one camera to adjust the color temperature of the screen according to the color temperature of the environment, based at least in part on the brightness indicated by the sensing data.

17. The method of claim 14, further comprising:
recognizing another color temperature of the environment by using the enabled at least one camera, before the color temperature of the environment used for adjusting the color temperature of the screen is recognized; and
setting time enabling the at least one camera to recognize the color temperature of the environment, based at least in part on the other color temperature.

18. The method of claim 14, further comprising:
setting timing obtaining data on the color temperature of the environment, based at least in part on the brightness indicated by the sensing data.

19. The method of claim 14, further comprising:
recognizing another color temperature of the environment by using the enabled at least one camera, before the color temperature of the environment used for adjusting the color temperature of the screen; and
setting timing obtaining data on the color temperature of the environment, based at least in part on the other color temperature.

20. One or more non-transitory computer readable storage media storing one or more computer programs including computer-executable instructions that, when executed by an electronic device individually or collectively, with at least one camera, an illuminance sensor, and a display, cause the electronic device to perform operations, the operations comprising:
checking, by the electronic device, a level of change of brightness of environment around the electronic device based on sensing data obtained by using the illuminance sensor, while a screen is displayed on the display and the at least one camera is disabled;
based on the level lower than a reference level, maintaining, by the electronic device, to disable the at least one camera; and
based on the level higher than or equal to the reference level:
enabling, by the electronic device, the at least one camera, and
adjusting, by the electronic device, a color temperature of the screen displayed on the display, according to color temperature of the environment recognized by using the enabled at least one camera.
